(19) United States
(12) Patent Application Publication
(10) Pub. No.: US 2015/0327531 A1
(43) Pub. Date: Nov. 19, 2015

(54) HORSESHOE

(71) Applicant: Blue Pegasos Pty Ltd., Ramsay (AU)

(72) Inventor: Marko Norbert HANNOVER, Ramsay (AU)

(73) Assignee: BLUE PEGASOS PTY LTD.

(21) Appl. No.: 14/287,043

(22) Filed: May 25, 2014

(30) Foreign Application Priority Data
May 14, 2014 (AU) 2014202636

(51) Int. Cl. A01L 1/04; A01L 5/00

(52) U.S. Cl. CPC A01L 1/04; A01L 5/00

(57) ABSTRACT

The horseshoe has a generally upside down U-shaped body with a front portion, side portions, rear ends, and an outer perimeter edge. The horseshoe includes a connector portion extending between and connecting the rear ends and being shaped to extend inwardly towards the front portion. The connector portion is generally V-shaped with the point of the V extending towards the front portion. The horseshoe defines an internal edge along internal edges thereof, and an internal space within the internal edge.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention relates to a horseshoe.

2. Description of Related Art Including Information Disclosed Under 37 CFR 1.97 and 37 CFR 1.98.

The present invention seeks to overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE INVENTION

According to a first aspect, the present invention provides a horseshoe made from a polyurethane elastomer material.

Preferably, the horseshoe has a generally upside down U-shaped body with a front portion and side portions, and a connector portion extending between and connecting rear ends of the side portions.

Preferably, the connector portion is generally V-shaped with the point of the V extending towards the front portion.

Preferably, the horseshoe comprises an upper surface and a lower surface, wherein the upper surface is generally smooth.

Preferably, the horseshoe further comprises spaced clips extending from a front edge of the upper surface, the clips being tabs to assist in locating the horseshoe on the horse's hoof during attachment.

Preferably, the lower surface comprises a tread pattern.

Preferably, the tread pattern is formed by a plurality of spaced protrusion blocks, the blocks being spaced by gaps therebetween.

Preferably, the horseshoe further comprises mounting holes formed between the blocks.

Preferably, the horseshoe is made from polyurethane composite having antibacterial properties.

Preferably, the horseshoe further comprises an insert, the insert comprising a central portion shaped to correspond to an internal space of the horseshoe defined between the front portion, side portions and the connector portion, the insert further comprising a perimeter extension along its lower edge, wherein the central portion in use is disposed within the internal space, the extension engages a lower surface of the horseshoe, and an upper surface of the central portion is substantially coplanar with an upper surface of the horseshoe.

Preferably, the horseshoe further comprises an insert, the insert comprising a central portion shaped to correspond to that of an internal space of the horseshoe defined between the front portion, side portions and the connector portion, the insert further comprising a perimeter extension along its lower edge, wherein the central portion in use is disposed within the internal space, the extension engages a lower surface of the horseshoe, and an upper surface of the central portion is recessed from an upper surface of the horseshoe.

Preferably, the horseshoe further comprises a wedge insert, the wedge insert comprising side sections and a connector section shaped to correspond to the side portions and the connector portion of the horseshoe, the thickness of the wedge insert increasing from a front end thereof to rear ends thereof.

Preferably, the horseshoe further comprises a wedge insert, the wedge insert comprising side sections shaped to correspond to the side portions portion of the horseshoe, the thickness of the site sections increasing from a front end thereof to rear ends thereof.

Preferably, the horseshoe allows light to pass therethrough.

Preferably, the horseshoe is at least partly translucent.

Preferably, the horseshoe is made from resilient material.

Preferably, the horseshoe further comprises spaced side-by-side tabs extending along external edges of the front portion and side portions.

Preferably, the tread pattern has a height of at least 7 mm.

Preferably, the horseshoe comprises two side clips and an upwardly angled ramp portion at a front edge of the upper surface disposed forwardly of the side clips.

Preferably, the horseshoe further comprises a cuff for attachment to the horseshoe, the cuff comprising a generally U-shaped base rim for attachment to an outer perimeter edge of the horseshoe, and a plurality of spaced fingers extending upwardly from the base rim, the fingers being angled inwardly towards each other.

The present invention also provides a kit comprising least two horseshoes according to any one of the above and attachment nails for attaching the horseshoes to a horse's hooves.

The present invention also provides a kit comprising at least two horseshoes according to any one of the above and attachment glue for attaching the horseshoes to a horse's hooves.

Other aspects of the invention are also disclosed.

### BRIEF DESCRIPTION OF THE DRAWINGS

Notwithstanding any other forms which may fall within the scope of the present invention, preferred embodiments of the present invention will now be described, by way of examples only, with reference to the accompanying drawings.

FIG. 1 is a top perspective view of a horseshoe in accordance with a preferred embodiment of the present invention.

FIG. 2 is a bottom perspective view of the horseshoe of FIG. 1.

FIG. 3 a top perspective view of a horseshoe in accordance with a second preferred embodiment of the present invention.

FIGS. 4a-4h are perspective views. FIG. 4a shows a sole or pedal bone insert, 4b shows the sole or pedal bone insert attached to the horseshoe, 4c shows a dirt or medical insert, 4d shows the dirt or medical insert attached to be horseshoe, 4e shows a full wedge attachment, 4f shows the wedge attachment attached to the horseshoe, 4g shows half wedge attachments, and 4h shows the half wedge attachments attached to the horseshoe.

FIG. 5 is a perspective view of a cuff for a horseshoe.

FIG. 6 is a perspective view of the cuff attached to a horseshoe.

### DETAILED DESCRIPTION OF THE DRAWINGS

It should be noted in the following description that like or the same reference numerals in different embodiments denote the same or similar features.

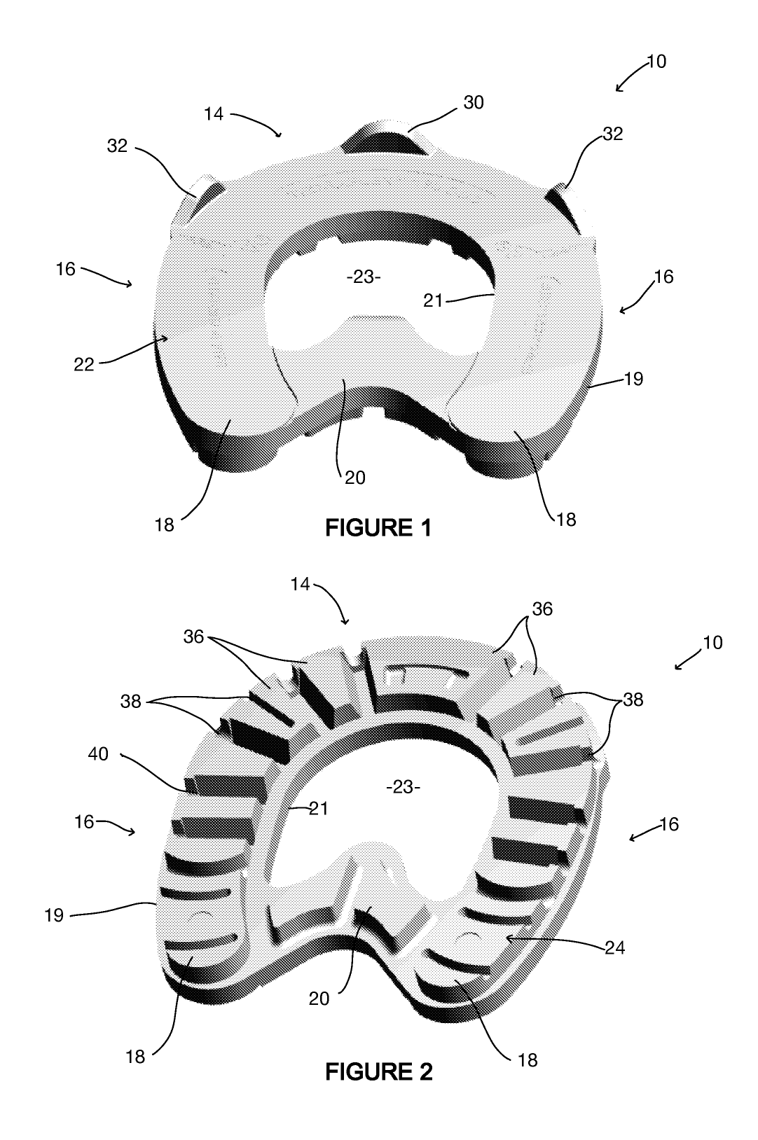

FIGS. 1 and 2 show a horseshoe 10 according to a preferred embodiment of the present invention. The horseshoe 10 is in the general shape of a horseshoe, having a generally upside down U-shaped body with a front portion 14, side portions 16, rear ends 18, and an outer perimeter edge 19. The horseshoe 10 further comprises a connector portion 20 extending between and connecting the rear ends 18 and shaped to extend inwardly towards the front portion 14. The connector portion 20 is generally V-shaped with the point of the V extending towards the front portion 14. The horseshoe 10 defines an internal edge 21 along internal edges thereof, and an internal space 23 within the internal edge 21.

The horseshoe 10 comprises an upper surface 22 and a lower surface 24. The upper surface 22 is generally smooth but can comprise spaced grip formations therealong to assist with gripping the lower surface of the horse's hoof in use.

The horseshoe 10 further comprises a front clip 30 and two side clips 32 extending from a front edge of the upper surface 22, which are tabs to assist in locating the horseshoe on the horse's hoof during attachment.

The lower surface 24 comprises a tread pattern formed by a plurality of spaced protrusion blocks 36. The blocks 36 are spaced by gaps 38 therebetween. Mounting holes 40 are formed between some of the blocks 36 (in the gaps 38) through which attachment nails 50 can be inserted for attaching the horseshoe 10 to the horse's hoof. In the embodiment, the tread pattern has a height of about 7.5 mm.

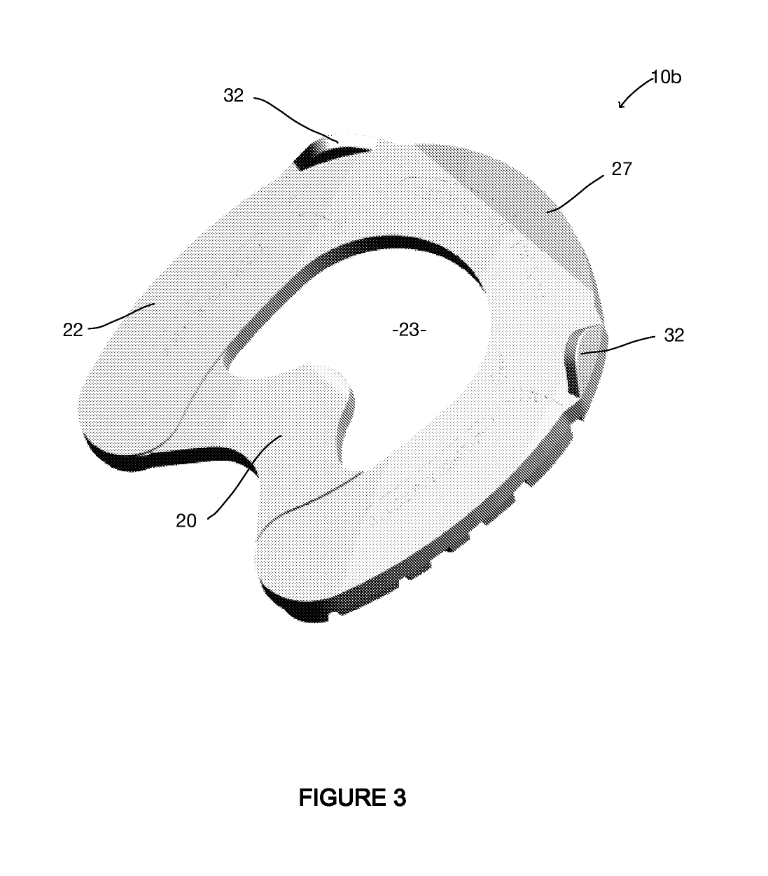

FIG. 3 shows a horseshoe 10b according to a second embodiment of the present invention. The horseshoe 10b is substantially similar to the horseshoe 10 described above and similar parts are indicated with similar reference numerals. The horseshoe 10b comprises the two side clips 32 but the front clip 30 is omitted. The horseshoe 10b comprises a rollover bar 27 instead of the front clip 30, the rollover bar 27 being an upwardly angled ramp portion at a front edge of the upper surface 22, disposed forwardly of the side clips 22. The rollover bar 27 is used for correcting a horse's gait in use.

The horseshoes 10 will typically be offered for sale in a kit format comprising two horseshoes 10 and nails for attaching the horseshoes 10 to a horse's hoof. The horseshoes 10 can also be applied to a hoof using glue only.

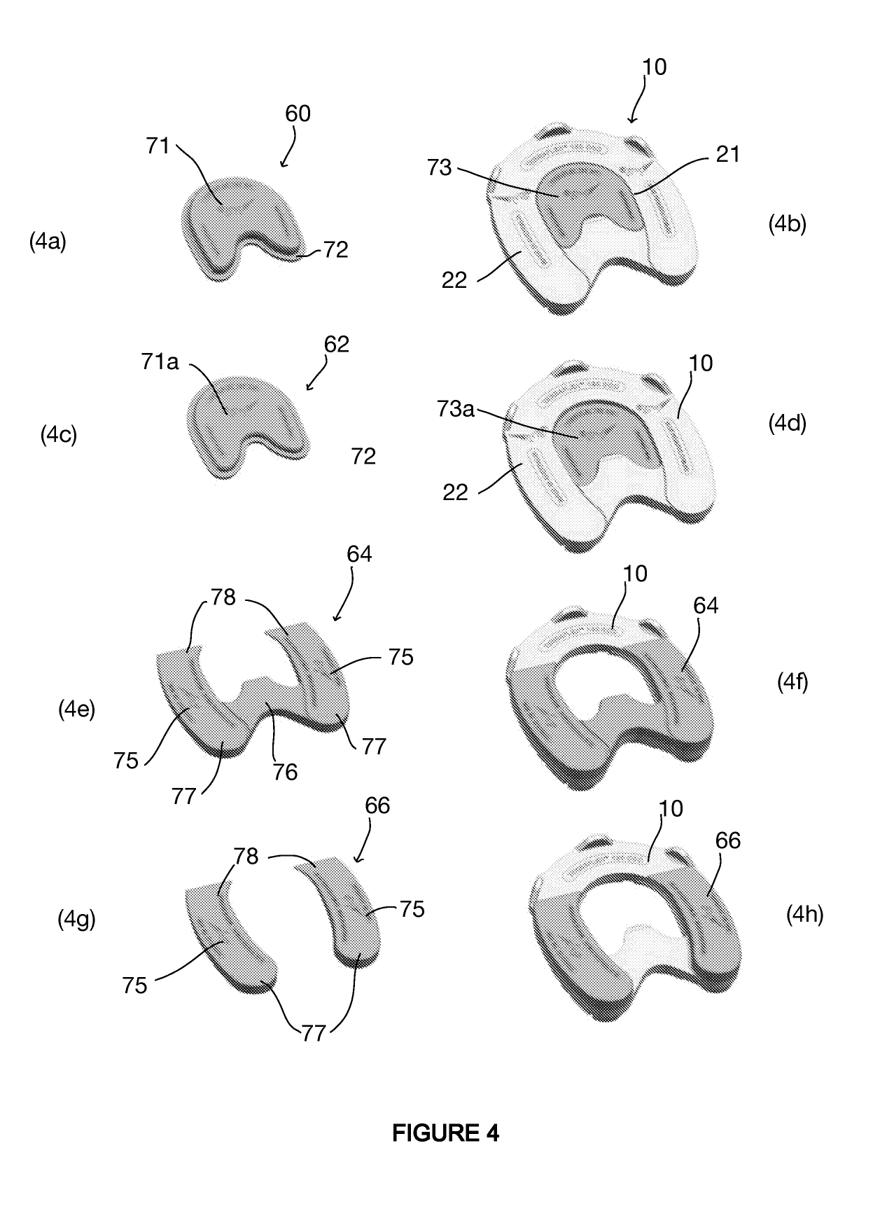

FIG. 4 shows a number of inserts that can be used with the horseshoe 10. These inserts include a sole or pedal bone insert 60, a dirt or medical insert 62, a full wedge insert 64, and half wedge inserts 66.

The sole or pedal bone insert 60 comprises a central portion 71 shaped to correspond to that of the internal space 23. In other words, the external perimeter shape of the central portion 71 corresponds to the internal edge 21. The insert 60 further comprises a perimeter extension 72 along its lower edge. The central portion 71 in use is disposed within the internal space 23. The extension 72 engages the lower surface 24 of the horseshoe 10, and an upper surface 73 of the central portion 71 is substantially coplanar with the upper surface 22 of the horseshoe 10.

The dirt or medical insert 62 is similarly shaped as the sole or pedal bone insert 60. The insert 62 however has a thinner central portion 71a. Thus, in use, the upper surface 73a of the insert 62 is slightly recessed below the upper surface 22 of the horseshoe 10.

The full wedge insert 64 comprises side sections 75 and a connector section 76 extending between rear ends 77 of the side sections 75. The side sections 75 and the connector section 76 are shaped in a similar manner as the side portions 16 and connector portion 20 of the horseshoe 10. The thickness of the wedge insert 64 increases from a front end 78 of the side sections 75, to the rearmost sections thereof adjacent the rear ends 77. In use, the full wedge insert 64 is disposed over the upper surface 22 of the horseshoe 10, over the corresponding side portions 16 and connector portion 20 thereof.

The half wedge inserts 66 correspond in shape to the side sections 75 of the wedge insert 64. The thickness of the wedge inserts 66 also increase from a front and 78 thereof to its rear and 77. The inserts 66 are thus essentially similar to the insert 64 but without the connector section 76. In use, the insert 66 are disposed over the upper surface 22 of the horseshoe 10, over the corresponding side portions 16 thereof.

The inserts 60 to 66 can be attached to the horseshoe 10 by a suitable glue.

The horseshoe 10 in the preferred embodiment is made from a polymer, being preferably polyurethane, more specifically a polyurethane elastomer. The polyurethane material is resilient and provides increased traction and shock absorbing properties for the horse's hoof. The horseshoes can be customized in terms of size, thickness and perimeter shape. In addition, the horseshoe can be made from different grades of polyurethane material for different needs. The horseshoe is lightweight and lasts longer than other shoes. The 100% polyurethane material provides flexibility, durability and cushioning of the hoof.

The horseshoe 10 can also be made from polyurethane (PU) composite which contains antibacterial properties to combat against hoof fungus.

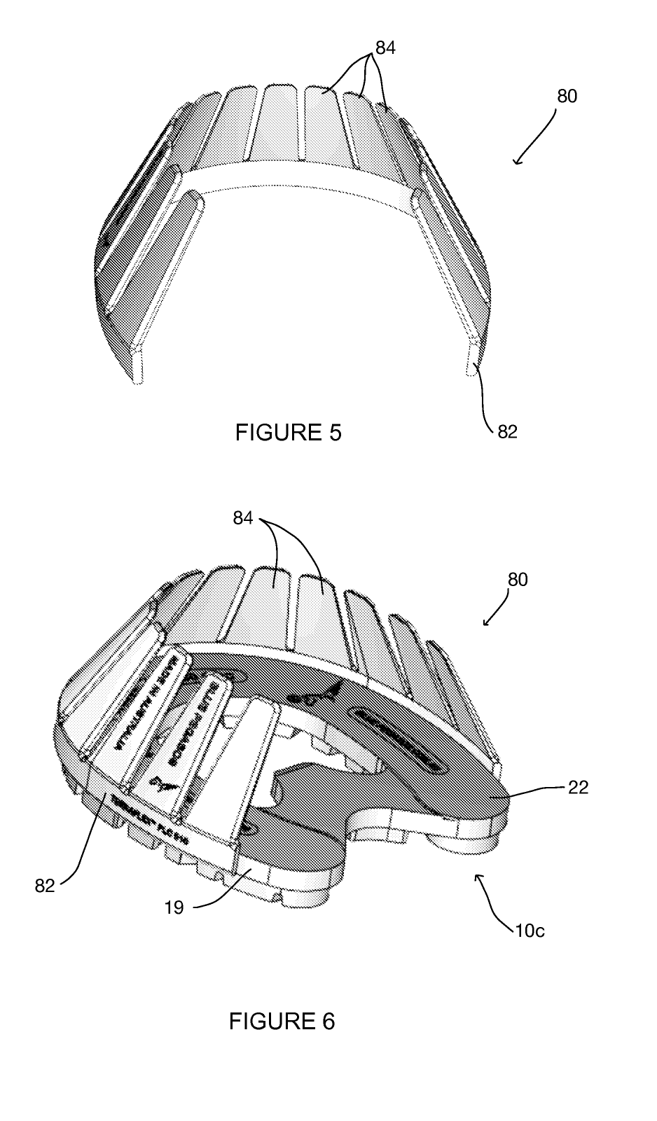

FIGS. 5 and 6 shows a cuff 80 and horseshoe 10c for attachment of the horseshoe 10c to a horse's hoof via glue only. The cuff 80 comprises a generally upside down U-shaped base rim 82 which follows the shape of the outer perimeter edge 19 of a horseshoe 10c. The horseshoe 10c has a flat upper surface and does not include any of the clips 30 and 32. The cuff 80 comprises a plurality of spaced flat fingers 84 extending upwardly from the base rim 82, with the fingers 82 being angled inwardly towards each other.

In use, the base rim 82 is glued to the outer perimeter edge 19 of the horseshoe 10c. The upper surface 22 and the fingers 84 provide surfaces for receiving glue and attachment to the horse's hoof.

The horseshoe 10 can be shaped to provide a wide rim in contrast to a steel horseshoe, to provide extra support around the rim of the hoof. Multiple sizing of the horseshoe are available and can be thus used for different sized or shaped hooves.

The spaced protrusion blocks 36 provide a high profile tread pattern for the horseshoe, which provides extra grip on slippery surfaces, clearance over small rocks, longer wear life, recessed nails and clearance of sole to ground.

The gaps 38 between the blocks 36 provides recessed nailing grooves, which allows the nail heads to be countersunk. This increases nail life and provides multiple positions for nails.

The horseshoe 10 also provides better frog support and better blood circulation for the frog of the hoof.

The horseshoe 10 is abrasive resistant, and slip resistant with excellent traction, and absorbs up to 90% of the concussion forces a horse experiences while wearing metal shoes.

The horseshoe 10 can be made in a number of different sizes, ranging in width from 119 m to 154 mm, length from 129 mm to 164 mm, and depth (thickness) from 15 mm to 15.5 mm. Other dimensions are also possible.

When compared to rubber or rubber compound shoes, the horseshoes 10 have proven in tests to be highly cut and tear resistant, greater in durability, more abrasive resistant, and sunlight, ozone and weather resistant

When compared to metal or metal compound shoes, the horseshoes 10 have proven in tests to be more or as durable as iron or aluminium shoes, as light as aluminium shoes, easier to fit and handle, highly abrasive and slip resistant, provide excellent hoof bonding properties, easier to customise, and concussion absorbing.

Compared to other plastic or plastic compound shoes, the horseshoes 10 have proven in tests to be flexible, returning to original shape when bent (resilient), unbreakable or does not become brittle, more resistant to impact, much higher in load bearing capacity, and highly chemical and heat resistant.

Applying the horseshoes 10 is less time consuming, with no anvil work, and they are easier to nail as they are translucent. The horseshoe 10 allows light to pass therethrough (at least partly translucent), at least at the locations of the gaps 38. This provides the ability for a farrier to see through the horseshoe for the correct nailing position on the hoof. Dirt and stones caught under the shoe can also be seen by the rider and easily attended to.

The horseshoe 10 works by providing a barrier between the horse's hoof and the ground, in order to decrease wear and tear on the hoof, and increase traction control. This is addressed in the following ways:

Protecting: The horseshoes protect and cushion the horse's hooves from damage which extends the use of the horse for competition and pleasure pursuits.

Absorbing: The horseshoes absorb shock and concussion due to the polyurethane manufactured base. Concussion is avoided and/or substantially limited when these shoes are on the galloping horse.

Preventing: The horseshoes substantially prevent leg injuries due to the polyurethane manufactured compound base. This means that hoof, leg, bones, ligaments, tendons, lung damage, and/or chronic lameness and/or unfitness in the long term is greatly reduced.

The horseshoes 10 also provide additional advantages as follows:

Traction: the horseshoes prevent the horse from slipping on loading ramps, on asphalt, cobble stones, or when walking or running, due to the increase in traction and slip resistance of the material.

Fitting/Attachment: The nailing of the shoe is simpler and safer. The nail can be moved freely and set easily with no risk to damage (pricking) to the hoof as the Farrier can see through the shoe. In contrast, metal shoes and some other synthetic shoes are opaque.

Relieving: The horseshoe relieves pressure, pain, and/or anxiety caused by metal shoes and hard plastic shoes.

Guiding: The horseshoe guides the horse back to his natural gaits as it improves his feeling on the ground which metal, plastic and/or rubber horse shoes lack.

Improving: the horse shoe improves the straightness of the gait.

Supporting: The horseshoe supports a healthy and faster growth of the hoof due to the increase of the blood circulation in the hoof. The horse shoe's profile traction provides excellent grip in all terrains and conditions.

Whilst preferred embodiments of the present invention have been described, it will be apparent to skilled persons that modifications can be made to the embodiments described. For example, the horseshoe can include spaced side-by-side clips (tabs) extending along the perimeter edge of the side portions and the front portion.

1. A horseshoe comprising: a polyurethane elastomer material.

2. The horseshoe of claim 1, being comprised of a generally upside down U-shaped body with a front portion and side portions, and a connector portion extending between and connecting rear ends of the side portions.

3. The horseshoe of claim 2, wherein the connector portion is generally V-shaped with a point of the V extending towards the front portion.

4. The horseshoe of claim 1, further comprising: an upper surface and a lower surface, wherein the upper surface is generally smooth.

5. The horseshoe of claim 4, further comprising spaced clips extending from a front edge of the upper surface, the clips being comprised of tabs so as to assist in locating during attachment.

6. The horseshoe of claim 4 wherein the lower surface comprises a tread pattern.

7. The horseshoe of claim 6, wherein the tread pattern is comprised of a plurality of spaced protrusion blocks, the blocks being spaced by gaps therebetween.

8. The horseshoe of claim 6 further comprising mounting holes formed between the blocks.

9. The horseshoe of claim 1, wherein the horseshoe is further comprised of polyurethane composite having antibacterial properties.

10. The horseshoe of claim 2, further comprising:
an insert comprising a central portion shaped to correspond to an internal space defined between the front portion, side portions and the connector portion, the insert further comprising a perimeter extension along a lower edge thereof, wherein the central portion in use is disposed within the internal space, the extension engages a lower surface, and an upper surface of the central portion is substantially coplanar with an upper surface.

11. The horseshoe of claim 2, further comprising:
an insert comprising a central portion shaped to correspond to an internal space defined between the front portion, side portions and the connector portion, the insert further comprising a perimeter extension along its a lower edge thereof, wherein the central portion in use is disposed within the internal space, the extension engages a lower surface, and an upper surface of the central portion is recessed from an upper surface.

12. The horseshoe of claim 2, further comprising:
a wedge insert, comprising side sections and a connector section shaped to correspond to the side portions and the connector portion of the horseshoe, a thickness of the wedge insert increasing from a front end thereof to rear ends thereof.

13. The horseshoe of claim 2, further comprising:
a wedge insert, comprising side sections shaped to correspond to the side portions portion of the horseshoe, a thickness of the side sections increasing from a front end thereof to rear ends thereof.

14. The horseshoe of claim 1, wherein light passes therethrough.

15. The horseshoe of claim 14, being at least partly translucent.

16. The horseshoe of claim 1, being comprised of resilient material.

17. The horseshoe of claim 2, further comprising spaced side-by-side tabs extending along external edges of the front portion and side portions.

18. The horseshoe of claim 4, wherein the tread pattern has a height of at least 7 mm.

19. The horseshoe of claim 5, further comprising two side clips and an upwardly angled ramp portion at a front edge of the upper surface disposed forwardly of the side clips.

20. The horseshoe of claim 1, further comprising a cuff for attachment, the cuff comprising a generally U-shaped base rim for attachment to an outer perimeter edge, and a plurality of spaced fingers extending upwardly from the base rim, the fingers being angled inwardly towards each other.
